(19) United States
(12) Patent Application Publication
(10) Pub. No.: US 2024/0408500 A1
(43) Pub. Date: Dec. 12, 2024

(54) VIDEOGAME PLATFORM WITH REAL-MONEY GAMING AUTHORIZATION AND METHOD OF USE THEREOF

(71) Applicant: ONMOBILE GLOBAL SOLUTIONS CANADA LIMITED, Montréal (CA)

(72) Inventors: Richard RISPOLI, Montréal (CA); Julien DURANTON, Montréal (CA); Olivier DELOUBRIERE, Rennes (FR)

(21) Appl. No.: 18/701,795

(22) PCT Filed: Oct. 20, 2022
(86) PCT No.: PCT/CA2022/051547

§ 371 Date: Apr. 16, 2024

Related U.S. Application Data
(60) Provisional application No. 63/257,996, filed on Oct. 20, 2021.

(51) Int. Cl. A63F 13/792; A63F 13/216; A63F 13/798

(52) U.S. Cl. CPC A63F 13/792; A63F 13/216; A63F 13/798

(57) ABSTRACT

A method of authorizing real-money gaming for a videogame selected by a user; it includes receiving a request from a user to play a target videogame from the plurality of videogames in a real-money gaming mode; receiving location information of the computing device of the user; analyzing the location information to determine a jurisdiction in which the computing device is located; retrieving a skill level value for the target videogame, wherein the skill level value is determined from a standard deviation of Elo ratings calculated for a plurality of sample users for the target videogame; retrieving a skill level threshold value for the jurisdiction; determining if the skill level value of the videogame meets the skill level threshold value for the jurisdiction.

The present application claims priority from U.S. provisional patent application No. 63/257,996 filed on Oct. 20, 2021, incorporated herein by reference.

### TECHNICAL FIELD

The present disclosure relates to videogame platforms, and more particularly to videogame platforms hosting videogames permitting real-money transactions.

### BACKGROUND

Real-money gaming involves games played through online media where real money can be wagered based on the outcome of the game.

Real-money gaming is tightly regulated in many jurisdictions, where the laws applicable in those jurisdictions may prohibit such games almost entirely, or may put into place certain criteria for determining if a particular game can include real-money gaming. In fact, many jurisdictions focus on the ratio between skill and chance required to succeed at a game in order to determine if real-money gaming is permitted, where real-money gaming usually requiring at least a certain level of skill.

For instance, a game such as chess involves mostly skill. On the other hand, such games as rolling a dice or flipping a coin depend on a large amount of chance. Other games, such as poker, rely mostly on chance but nonetheless involve a degree of skill.

Some jurisdictions may provide for a threshold value for the level of skill required to permit real money gaming. This threshold value varies between jurisdictions. In some jurisdictions, there may not be a set value for a threshold level of skill, but instead the jurisdiction may provide one or more examples of games with a minimum amount of skill to play that are eligible for real-money gaming.

As such, due to the differences in threshold levels found in different jurisdictions, as well as the difference in comparators used by different jurisdictions (e.g. a skill-chance ratio value; an exemplary game; an exemplary outcome, etc.), it becomes challenging for a videogame platform, hosting a plurality of videogames each involving different ratios of skill and chance, to determine which videogame can include real-money gaming. Moreover, when users are located around the world, the permission to enable real-money gaming for a given game may also depend upon the location of the user's computer device as the user plays the videogame, as the location in which the user is found may determine which laws apply to that user, those laws determinative of if the user may participate in real-money gaming for that given game.

Videogame platforms may be held liable in certain jurisdictions if they do not maintain a system for verifying the admissibility of videogames for real-money gaming before hosting same through their platform.

### SUMMARY

Certain publications have described the use of Elo ratings in order to calculate a value of skill for a particular game. For instance, reference is made to Duersch et al., Measuring Skill and Chance in Games, University of Heidelberg, Department of Economics, No. 643, December 2017. However, the theorems described in such publications have not been adapted for videogame platforms.

The present disclosure relates to a system for authorizing real-money gaming for use with a videogame platform hosting a plurality of videogames. The videogame platform grants access to remote users, using their personal computing device (e.g. desktop computer, tablet computer, smartphone, laptop computer), to the videogames hosted thereon, including, when permissible, a mode for real-money gaming when playing the videogame.

The computing device of the user accessing the videogame platform may be located in multiple countries.

Therefore, the system verifies the location of the computing device of a user, and determines if real-money gaming is permissible in the jurisdiction in which the computing device of the user is located based on a skill rating value calculated for the videogame selected by the user and the laws applicable in the jurisdiction of the computing device of the user.

The skill value rating for a given videogame is determined from a set of Elo ratings calculated for a plurality of sample players during a trial session for the videogame using virtual currency instead of real money.

The win-loss data of the games played by the plurality of sample players is used to calculate the Elo ratings. A grid-search algorithm is used to find an optimal k factor to calculate the Elo ratings for the players, adjusted to minimize the sum of the total loss across the entire dataset, yielding the k* factor.

A standard deviation is then calculated for the adjusted Elo ratings of the plurality of sample players. The standard deviation is then equated to a skill level value, quantifying the ratio between skill and chance, for the given videogame.

A threshold skill level value can also be determined or stored for a given jurisdiction.

The calculated skill level value for the given videogame is then compared to the skill level value for the jurisdiction. If the skill level value for the given videogame is greater than or equal to the threshold skill level value for the jurisdiction, then real-money gaming is authorized for the user located in that jurisdiction. In contrast, if the skill level value for the given videogame is less than the threshold skill level value for the jurisdiction, then real-money gaming is disabled for the user located in that jurisdiction.

A broad aspect is a method of authorizing real-money gaming for a videogame selected by a user, through a computing device of the user, amongst a plurality of videogames hosted on a videogame platform. The method includes receiving a request from a user to play a target videogame, from the plurality of videogames, in a real-money gaming mode; receiving location information of the computing device of the user; analyzing the location information to determine a jurisdiction in which the computing device is located; retrieving a skill level value for the target videogame, wherein the skill level value is determined from a standard deviation of Elo ratings calculated for a plurality of sample users for the target videogame; retrieving a skill level threshold value for the jurisdiction; and determining if the skill level value of the videogame meets the skill level threshold value for the jurisdiction, wherein real-money gaming is authorized for the target videogame if the skill level value of the videogame meets the skill level threshold value for the jurisdiction.

In some embodiments, the skill level value is further determined by running a trial session for the target videogame in a virtual currency mode including a plurality of matches between the sample users to generate win-loss data; calculating the Elo rating values for each of the sample users based on an analysis of the win-loss data including the wins and losses between the plurality of sample users during the matches; calculating the standard deviation from the calculated Elo rating values; and computing the skill level value for the selected video from the standard deviation.

In some embodiments, the method may include, prior to the computing of the skill level value, determining a confidence interval for the standard deviation by modifying some of the data of the win-loss data.

In some embodiments, the modifying of some of the data of the win-loss data may include removing some of the data associated with one or more of the matches.

In some embodiments, the modifying of some of the data of the win-loss data may include adding additional data to the win-loss data by including further matches between the sample users.

In some embodiments, the calculating of the Elo rating values may be performed using a grid-search algorithm.

In some embodiments, the grid-search algorithm may be adjusted to minimize a sum of total losses across an entire dataset of the calculated Elo ratings.

In some embodiments, the request received from the user may include information on a version of the videogame to be played, and wherein the retrieving the skill level value for the videogame may be performed using a query including information on the version of the videogame such that the retrieved skill level value for the videogame is specific to the version of the videogame.

In some embodiments, the method may include receiving age information for the user including an age value for the user; receiving a value for a minimum authorized age for the jurisdiction for permitting real-money gaming; and comparing the age value for the user to the value for the minimum authorized age, wherein real-money gaming is authorized for the target videogame if the skill level value of the videogame meets the skill level threshold value for the jurisdiction and if the age value for the user meets the value of the minimum authorized age.

In some embodiments, the age information may be received with the request.

In some embodiments, the age information may be received following a generating of a query based on user information of the user provided in the request, wherein the query is for retrieval of the age information associated with the user information.

Another broad aspect is a method of calculating a skill level value for a target videogame, wherein the target videogame includes a real-money gaming mode, and wherein the skill level value provides an indicator of a level of skill required to play the videogame and is usable to determine if real-money gaming is permitted for the videogame when played by a user located in a given jurisdiction. The method includes running a trial session for the target videogame in a virtual currency mode including a plurality of matches between sample users to generate win-loss data;
calculating the Elo rating values for each of the sample users based on an analysis of the win-loss data including the wins and losses between the plurality of sample users during the matches; calculating a standard deviation from the calculated Elo rating values; and computing the skill level value for the selected video from the standard deviation.

In some embodiments, the method may include, prior to the computing of the skill level value, determining a confidence interval for the standard deviation by modifying some of the data of the win-loss data.

In some embodiments, the modifying of some of the data of the win-loss data may include removing some of the data associated with one or more of the matches.

In some embodiments, the modifying of some of the data of the win-loss data may include adding additional data to the win-loss data by including further matches between the sample users.

In some embodiments, if the confidence interval does not meet a minimal confidence value, the running may be repeated to generate additional win-loss data, the calculating the Elo rating values may be repeated by being further based on the additional win-loss data to yield new Elo rating values, and a new standard deviation may be calculated from the new Elo rating values.

In some embodiments, the calculating of the Elo rating values may be performed using a grid-search algorithm.

In some embodiments, the grid-search algorithm may be adjusted to minimize a sum of total losses across an entire dataset of the calculated Elo ratings.

In some embodiments, the running, the calculating the Elo rating values, the calculating the standard deviation, and the computing the skill level value may be repeated when the target videogame receives an update.

Another broad aspect is a computing device configured to authorize real-money gaming for a videogame selected by a user, through a computing device of the user, amongst a plurality of videogames hosted on a videogame platform. The computing device includes a processor; and memory storing program code that, when executed by the processor, causes the processor to receive a request from a user to play a target videogame from the plurality of videogames in a real-money gaming mode; receive location information of the computing device of the user; analyze the location information to determine a jurisdiction in which the computing device is located; retrieve a skill level value for the target videogame, wherein the skill level value is determined from a standard deviation of Elo ratings calculated for a plurality of sample users for the target videogame; retrieve a skill level threshold value for the jurisdiction; and determine if the skill level value of the videogame meets the skill level threshold value for the jurisdiction, wherein real-money gaming is authorized for the target videogame if the skill level value of the videogame meets the skill level threshold value for the jurisdiction.

In some embodiments, the memory further may include program code that, when executed by the processor, causes the processor to determine the skill level value by running a trial session for the target videogame in a virtual currency mode including a plurality of matches between the sample users to generate win-loss data; calculating the Elo rating values for each of the sample users based on an analysis of the win-loss data including the wins and losses between the plurality of sample users during the matches; calculating a standard deviation from the calculated Elo rating values; and
computing the skill level value for the selected video from the standard deviation.

In some embodiments, the memory may include program code that, when executed by the processor, causes the processor to determine a confidence interval for the standard deviation by modifying some of the data of the win-loss data.

In some embodiments, the modifying of some of the data of the win-loss data may include removing some of the data associated with one or more of the matches.

In some embodiments, the modifying of some of the data of the win-loss data may include adding additional data to the win-loss data by including further matches between the sample users.

In some embodiments, the calculating of the Elo rating values may be performed using a grid-search algorithm.

In some embodiments, the memory may include program code that, when executed by the processor, causes the processor to adjust the grid-search algorithm to minimize a sum of total losses across an entire dataset of the calculated Elo ratings.

In some embodiments, the request received from the user may include information on a version of the videogame to be played, and wherein the retrieving the skill level value for the videogame may be performed using a query including information on the version of the videogame such that the retrieved skill level value for the videogame is specific to the version of the videogame.

In some embodiments, the memory may include program code that, when executed by the processor, causes the processor to receive age information for the user including an age value for the user; receive a value for a minimum authorized age for the jurisdiction for permitting real-money gaming; and compare the age value for the user to the value for the minimum authorized age, wherein real-money gaming is authorized for the target videogame if the skill level value of the videogame meets the skill level threshold value for the jurisdiction and if the age value for the user meets the value of the minimum authorized age.

In some embodiments, the age information may be received with the request.

In some embodiments, the age information may be received following a generating of a query based on user information of the user provided in the request, wherein the query may be for the retrieval of the age information associated with the user information.

Another broad aspect is a computing device configured to calculate a skill level value for a target videogame, wherein the target videogame including a real-money gaming mode, and wherein the skill level value provides an indicator of a level of skill required to play the videogame and is usable to determine if real-money gaming is permitted for the videogame when played by a user located in a given jurisdiction. The computing device includes a processor; and memory including program code that, when executed by the processor, cause the processor to run a trial session for the target videogame in a virtual currency mode including a plurality of matches between sample users to generate win-loss data; calculate Elo rating values for each of the sample users based on an analysis of the win-loss data including the wins and losses between the plurality of sample users during the matches; calculate a standard deviation from the calculated Elo rating values; and compute the skill level value for the selected video from the standard deviation.

In some embodiments, the memory further may include program code that, when executed by the processor, cause the processor to, prior to the computing of the skill level value, determine a confidence interval for the standard deviation by modifying some of the data of the win-loss data.

In some embodiments, the modifying of some of the data of the win-loss data may include removing some of the data associated with one or more of the matches.

In some embodiments, the modifying of some of the data of the win-loss data may include adding additional data to the win-loss data by including further matches between the sample users.

In some embodiments, if the confidence interval does not meet a minimal confidence value, the running may be repeated to generate additional win-loss data, the calculating the Elo rating values may be repeated by being further based on the additional win-loss data to yield new Elo rating values, and a new standard deviation may be calculated from the new Elo rating values.

In some embodiments, the calculating of the Elo rating values may be performed using a grid-search algorithm.

In some embodiments, the grid-search algorithm may be adjusted to minimize a sum of total losses across an entire dataset of the calculated Elo ratings.

In some embodiments, the running, the calculating the Elo rating values, the calculating the standard deviation, and the computing the skill level value may be repeated when the target videogame receives an update.

Another broad aspect is a non-transitory storage medium including program code that, when executed by a processor, cause the processor to receive a request from a user to play a target videogame from the plurality of videogames in a real-money gaming mode; receive location information of the computing device of the user; analyze the location information to determine a jurisdiction in which the computing device is located; retrieve a skill level value for the target videogame, wherein the skill level value is determined from a standard deviation of Elo ratings calculated for a plurality of sample users for the target videogame; retrieve a skill level threshold value for the jurisdiction; and determine if the skill level value of the videogame meets the skill level threshold value for the jurisdiction, wherein real-money gaming is authorized for the target videogame if the skill level value of the videogame meets the skill level threshold value for the jurisdiction.

Another broad aspect is a non-transitory storage medium including program code that, when executed by a processor, cause the processor to run a trial session for the target videogame in a virtual currency mode including a plurality of matches between sample users to generate win-loss data; calculate Elo rating values for each of the sample users based on an analysis of the win-loss data including the wins and losses between the plurality of sample users during the matches; calculate a standard deviation from the calculated Elo rating values; and compute the skill level value for the selected video from the standard deviation.

### BRIEF DESCRIPTION OF THE DRAWINGS

The invention will be better understood by way of the following detailed description of embodiments of the invention with reference to the appended drawings, in which:

FIG. 1 is a block diagram of exemplary hardware of an exemplary system for authorizing real-money gaming of videogames hosted on an exemplary videogame platform;

FIG. 2 is a block diagram of an exemplary software architecture for authorizing real-money gaming of videogames hosted on an exemplary videogame platform;

FIG. 3 is an event flow diagram of an exemplary method of authorizing real-money gaming of videogames hosted on an exemplary videogame platform;

FIG. 4 is a flowchart diagram of an exemplary method of calculating a skill level value for an exemplary videogame; and

FIG. 5 is a flowchart diagram of an exemplary method of authorizing real-money gaming of videogames hosted on an exemplary videogame platform.

### DETAILED DESCRIPTION

The present disclosure relates to a system for verifying the eligibility of a videogame hosted on a videogame platform for real-money gaming. Upon verifying that the videogame is eligible for real-money gaming, the system authorizes real-money gaming for a given user (based on the location of the computing device of the user, and optionally, other conditions required in that jurisdiction).

The system performs the eligibility analysis for real-money gaming upon the user's request to access the videogame through the user's personal computer, as the location of the user is used to determine a threshold skill-level value applicable in the jurisdiction in which the user is located, based on the laws applicable in that jurisdiction.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

From the foregoing it will be appreciated that, although specific embodiments have been described herein for purposes of illustration, various modifications may be made without deviating from the spirit and scope of the teachings. Accordingly, the claims are not limited by the disclosed embodiments.

### Exemplary Hardware Infrastructure for a System for Verifying the Eligilbity of a Videogame for Real-Money Gaming:

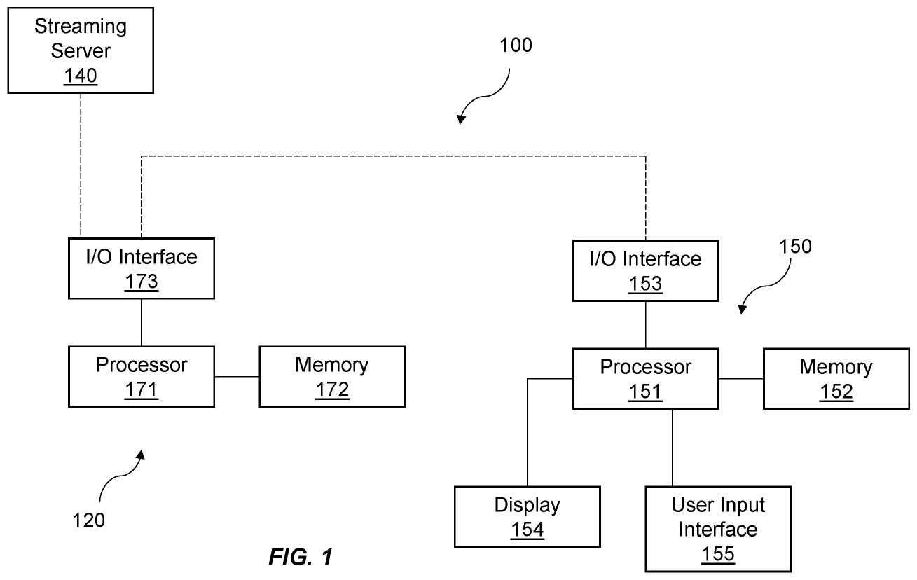

Reference is made to FIG. 1, illustrating an exemplary system 100 for assessing eligibility for real-money gaming for one or more videogames hosted on a videogame platform, accessible by a plurality of users, using their respective personal computing devices.

The system 100 includes a server 120 and may interact with one or more computing devices 150 (e.g. via the web) of users from which the videogame platform may be accessed, and the videogame may be played. For instance, the videogames hosted by the videogame platform may be accessible from an application program for the videogame platform stored in memory 152 of the computing device 150, generating a graphical user interface on the display of the computing device 150. The application program then communicates via the Internet with the server 120 for accessing game data of the videogames. In other examples, the videogame platform may be accessed through a website for the videogame platform, where the videogame may be played through the website.

The server 120 has a processor 171, memory 172 and an input/output interface 173.

The processor 171 may be a general-purpose programmable processor. In this example, the processor 171 is shown as being unitary, but the processor may also be multicore, or distributed (e.g. a multi-processor).

The computer readable memory 172 stores program instructions and data used by the processor 171. The memory 172 may be non-transitory. The computer readable memory 172, though shown as unitary for simplicity in the present example, may comprise multiple memory modules and/or cashing. In particular, it may comprise several layers of memory such as a hard drive, external drive (e.g. SD card storage) or the like and a faster and smaller RAM module. The RAM module may store data and/or program code currently being, recently being or soon to be processed by the processor 171 as well as cache data and/or program code from a hard drive. A hard drive may store program code and be accessed to retrieve such code for execution by the processor 171 and may be accessed by the processor 171 to store, skill threshold values, Elo rating values, user performance data, etc. as explained herein. The memory 172 may have a recycling architecture for storing, for instance, user performance data, Elo ratings, win-loss data, k values, etc., where older data files are deleted when the memory 172 is full or near being full, or after the older data files have been stored in memory 172 for a certain time.

The input/output interface 173 is in communication with the processor 171. The I/O interface 173 is a network interface and may be a wireless interface for establishing a remote connection with an external server (e.g. through an application program interface as described herein), one or more computing devices 150, etc. For instance, the I/O interface 173 may be an Ethernet port, a WAN port, a TCP port, etc.

The processor 171, the memory 172 and the I/O interface 173 may be linked via BUS connections.

The computing device 150 is the device on which the user plays the videogame.

The computing device 150 has a processor 201, memory 202, a display 204, a user input interface 205, an I/O interface 203.

The memory 202 may store program code for a videogame or videogame platform that, when executed by the processor 201, causes the processor 201 to generate on the display 204 a graphical user interface providing a selection of videogames for the user to select from. The videogame and/or videogame platform may also be accessible via the web, where data for the videogame and/or videogame platform may be stored on a remote server (e.g. remote server 120).

The user input interface 205 may be a keyboard, a mouse, a touchscreen (where the display is a touchscreen and also serves as a user input interface), a microphone, one or more accelerometers to ascertain movements of the computing device or of a peripheral held by the user, a proximity sensor or camera to detect movements and/or position of the user, etc.

The user accesses the videogame platform using the computing device 150, where the user selects a videogame available from the videogame platform to play. The system then determines if real-money gaming is permissible for the user when playing the selected videogame as explained herein.

### Exemplary Software Architecture for Authorizing Real-Money Gaming:

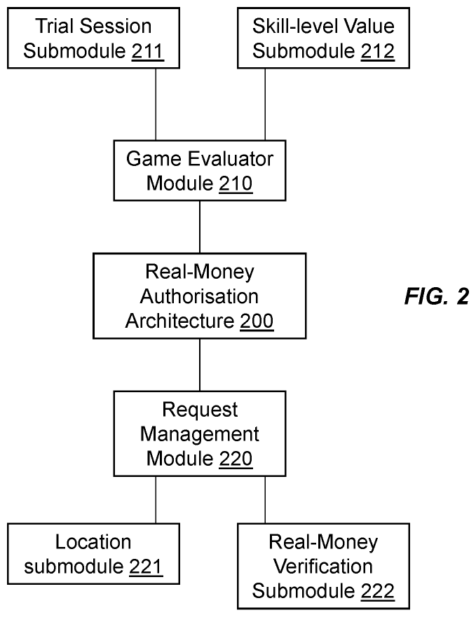

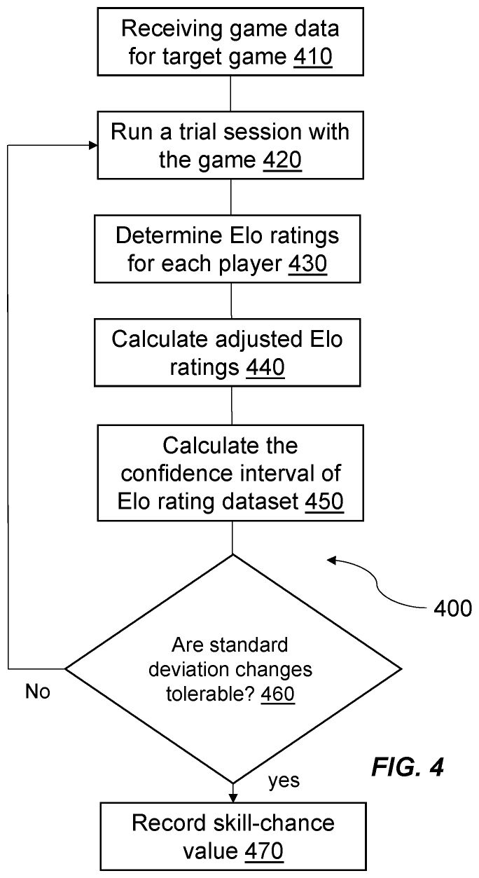

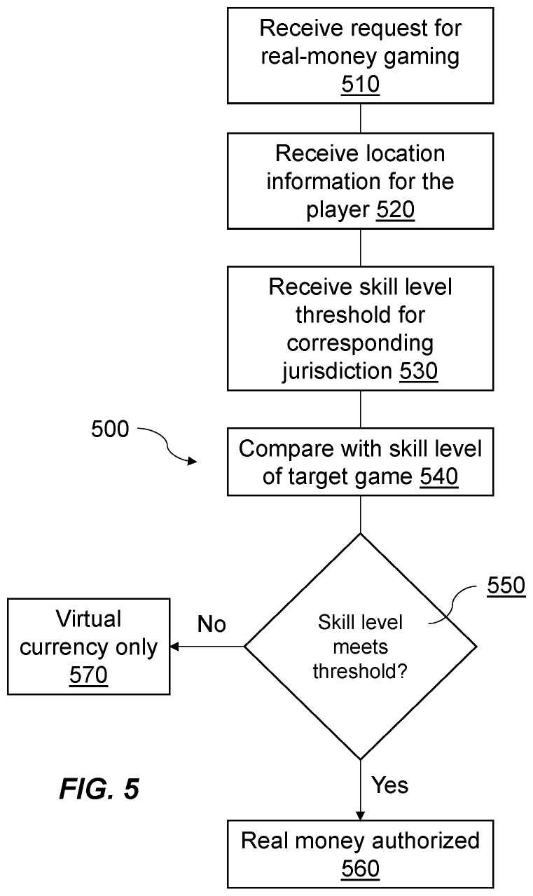

For purposes of illustration, the software architecture 200 for authorizing real-money gaming, as detailed in the methods detailed in each of FIGS. 4 and 5, may be divided into the modules illustrated in FIG. 2. However, it will be understood that the division of the software into modules is but for purposes of illustration, and that the software architecture may be divided or organized in other manners without departing from the present teachings. Therefore, the organization of the software architecture of FIG. 2 is only for purposes of illustration, to better describe the present teachings, and does not limit the structure of the software to the structure presented in FIG. 2. The software architecture 200 may be stored in memory 172 of the system 100.

The real-money authorisation architecture 200 includes program code that, when executed by the processor, causes the processor to generate a skill-level value for a given videogame hosted or to be hosted on the videogame platform, and to authorize real-money gaming for a user requesting same for a particular videogame hosted on the videogame platform.

The real-money authorisation architecture 200 includes a game evaluator module 210 and a request management module 220.

The game evaluator module 210 includes a trial session submodule 211 and a skill-level submodule 212.

The request management module 220 includes a location submodule 221 and a real-money verification submodule 222.

The game evaluator module 210 includes program code that, when executed by the processor, causes the processor to both collect win-loss data on users participating in a trial-session of the videogame, and to generate a skill-level value for that videogame based on the win-loss data.

The trial-session submodule 211 includes program code that, when executed by the processor, causes the processor to receive win-loss data associated with users engaged in a trial session for a given videogame. The trial-session submodule 211 may store the received win-loss data for the videogame as a dataset associated with an identifier for that videogame in memory 172 or an external database. In some embodiments, the trial-session submodule 211 receives data that a new videogame has been added to the videogame platform, or that an existing videogame on the videogame platform has been updated, and sets the videogame in a virtual-currency mode. The videogame may then be accessed on the videogame platform by users of the videogame platform. However, the users may only engage with the game in virtual currency mode.

The trial-session submodule 211 may also include program code that, when executed by the processor, causes the processor to verify if the win-loss data of the stored dataset for the designated videogame is of sufficient size and/or detail (e.g. a sufficient large amount of different users have played the videogame in virtual-currency mode). The verification may be performed by comparing the dataset with one or more values (e.g. a size value, etc.) Prior to the comparison, the dataset may be analyzed by the processor executing the trial-session submodule 211 to extract parameters, characteristics, values of the dataset (e.g. number of users with relevant win-loss data; total time played; number of matches, etc.) If the verification performed by the processor executing the trial-session submodule 211 indicates that the condition(s) has(ve) been met, the skill-level value submodule 212 is called.

The skill-level value submodule 212 includes program code that, when executed by the processor, causes the processor to calculate the skill-level value for the videogame from the user Elo ratings determined from the win-loss data. The skill-level value, the standard deviation, the Elo ratings may be stored in a database or memory 172. Once a skill-level value has been calculated for a given videogame, or videogame update, the skill-level value submodule 212 may then cause the processor to generate a command to enable a selection of a real-money gaming mode for the given videogame.

The request management module 220 includes program code that, when executed by the processor, causes the processor to receive a request from a user to play a videogame on the videogame platform in real-money gaming mode, when a real-money gaming mode has been enabled for that videogame, and to either unauthorize or authorize same based on the jurisdiction in which the user is located, the laws applicable in that jurisdiction, and the skill-level value that has been calculated for that given videogame.

The location submodule 221 includes program code that, when executed by the processor, causes the processor to receive data on the computing device of the user pertaining to the location of the computing device, optionally determine the jurisdiction of the computing device of the user, and retrieve from memory (e.g. an external database, memory 172), one or more conditions for permitting real-money gaming for that jurisdiction. The location submodule 221 then transmits information (e.g. values, rules to verify the conditions) on the conditions for that jurisdiction (optionally with an identifier for that jurisdiction) to the real-money verification submodule 222.

The real-money verification submodule 222 includes program code that, when executed by the processor, causes the processor to receive the request from the user to play a videogame hosted by the videogame platform in real-money currency mode, optionally call the location submodule 221 to retrieve the conditions for the jurisdiction in which the computing device of the requesting user is located, receive from the location submodule 221 the conditions for the jurisdiction in which the computing device of the requesting user is located, retrieve from memory the skill-level value for the requested videogame, and verify if real-money gaming is permitted for that videogame for the requesting user.

The real-money verification submodule 222 may also include program code that, when executed by the processor, causes the processor to output a command to authorize or disable real-money gaming for that user. The command may be transmitted to a software module that includes program code to, when executed by the processor, cause the processor to manage the account permissions for that user in a user profile, causing the setting of a real-money gaming parameter for the requesting videogame to “on” or “off” in the user profile, depending on if real-money gaming is authorized or nor for the computing device of that user in the current jurisdiction.

As the location of the computing device of the user may impact the authorization for real-money gaming for a particular game, the verification of eligibility of real-money gaming may be performed again each time the user requests to play a videogame in a real-money gaming mode, if a request is made after a certain period of time, if location data received by a user following a request indicates that the computing device of the user has undergone a change of location, etc.

### Exemplary Method of Authorizing Real-Money Transactions for a Videogame:

Reference is now made to FIG. 5, illustrating an exemplary method 500 of authorizing real-money gaming for a videogame, selected by a user, hosted on a videogame platform. For illustrative purposes, reference will be made to the system 100 and to software architecture 200. However, it will be understood that other systems and/or software architectures 200 in accordance with the present teachings may be used.

The user accesses the videogame platform and provides input to play a given videogame available on the videogame platform (e.g. selects a videogame from a library of videogames available on the videogame platform; receives a request from another player to join in playing a videogame available on the videogame platform in real-money currency, etc.)

As such, the server 120 (e.g. the real-money verification submodule 222) receives a request (based on data from the user's input corresponding to a selection to play a videogame in real-money currency), at the I/O interface 173, from the user to play the given videogame in a real-money mode at step 510. The request may include metadata on the IP address associated with the user account, the name of the user or the player's avatar, the age of the player, the user account identification information, the name of the selected videogame or any other identification information for the selected videogame, the version (e.g. based on updates to the videogame) of the videogame that has been selected by the user, etc. The request may also include location information (e.g. through one or more of GPS coordinates, Bluetooth, Wi-Fi hotspot and cell tower locations, etc.) on the location of the computing device 150 of the user used to select the videogame. In some embodiments, the processor 171 of the server 120 may have to first query the computing device 150 for location information of the computing device 150, through I/O interface 173, before receiving from the computing device 150 location information on the computing device 150 of the user.

In some embodiments, the videogame platform may forbid a user from playing videogames in real-money if the server 120 does not first receive location information on the user (e.g. because the user has not allowed the application program for the videogame platform to collect location information from the computing device 150).

As such, the server 120, through I/O interface 173, receives location information on the computing device 150 of the user at step 520.

The processor 171 of the server 120, e.g. by executing the program code of location submodule 221, then analyzes the location information of the computing device 120 to determine the jurisdiction corresponding to the location information. For instance, with GPS coordinates, the processor 171 may compare the GPS coordinates with a virtual map or coordinate system to determine the jurisdiction that includes the GPS coordinates. The processor 171 may output a string of characters spelling the given jurisdiction.

The processor 171 then executes instructions corresponding to, e.g., location submodule 221, to generate a query to retrieve from memory 172 a skill-level threshold value for the identified jurisdiction, the skill-level threshold value corresponding to the amount of skill required to permit real-money gaming in that jurisdiction. The query may include a string of characters for identifying the jurisdiction in question, based from the jurisdiction determined from the location information of the computing device 150 of the requesting user. The string of characters of the query may then be parsed and compared with jurisdiction-labels in memory, each identifying a given skill-level threshold value for that jurisdiction.

The processor 171 then executes code (e.g. of real-money verification submodule 222) to parse the received user request to play a videogame to determine the identity of the videogame that is included in the request (analyzing an identifier of the selected videogame included in the received request).

A query is then generated by the processor 171, executing code stored in memory 172 (e.g. of real-money verification submodule 222), to retrieve from memory 172 a calculated skill-level value for the identified videogame. An exemplary method for calculating the skill-level value for a videogame is illustrated in FIG. 4. The query may include a string of characters for identifying the videogame in question. The string of characters of the query may then be parsed and compared with videogame-labels in memory, each identifying a given skill-level value calculated for that videogame (the calculation of the skill-level value for a videogame explained with regard to FIG. 4). The retrieved skill-level value for that videogame is then received at the processor 171 at step 530.

The retrieved skill-level value of the videogame is then compared with the retrieved skill-level threshold value for the given jurisdiction at step 540.

A comparison is then performed at step 550, using comparators such as “≥”, “≤”, “<”, “>”, to return, e.g., a Boolean value. For instance, if the skill-value for the videogame is equal to or greater than the skill-level value for the given threshold value, then the Boolean value may be set to “true”, and real money is authorized at step 560.

However, in this example, if the skill-value for the videogame is less than the skill-level value for the given threshold value, then the Boolean value is set to “false”, and only virtual currency is permitted for the selected videogame at step 570. It will be understood that other comparators may be used.

When real-money gaming is forbidden for a given user and a given videogame following a user request for same, a message may be transmitted to the computing device 150 of the user via I/O interface 173 by processor 171 executing the program code corresponding to, e.g., real-money verification submodule 222, the message including a string of characters explaining to the user that real-money gaming is not possible or suggesting to pay the game in a virtual-currency mode. The message may also include information (e.g. icons, links, strings of characters, etc.) on videogame suggestions for other videogames hosted on the videogame platform where real-money gaming is possible. In this example, following receipt of a request from a user to play a videogame with real-money currency at step 510, after the skill level threshold value has been retrieved for the jurisdiction corresponding to the location information of the computing device of the requesting user, a query may also be generated with the threshold skill-level value for the jurisdiction to retrieve strings of characters corresponding to names of videogames that have a skill-level value that is equal to or higher than the skill-level threshold value for the designated jurisdiction. The names of these alternative videogames (and/or their icons, a shortcut to have access thereto, etc.) may also be transmitted to the requesting user via I/O interface 173, presented as a message to the user on the display of the computing device 150 of the user.

As such, the exemplary method 500 enables contemporaneous authorization of requests made by videogame users, requesting to play videogames in real-money gaming, by verifying that the user is located in a jurisdiction permitting real-money gaming before authorizing real-money gaming for that user. Therefore, the videogame platform includes a level of security to confirm that real-money gaming is permissible in the jurisdiction in which the user is located, thereby providing a defence against accusations of unlawful real-money gaming made by a jurisdiction towards the videogame platform.

It will be understood that other characteristics of the user, based on information shared with the user via the computing device 150 of the user, may be analyzed to further ascertain if real-money gaming is possible. For instance, a value for the age of the user may also be included in a query for the given jurisdiction. A return for the query on the conditions required for allowing real-money gaming in a given jurisdiction may not only includes the skill-level threshold value for the jurisdiction, but also a possible minimal age value for that jurisdiction for permitting real-money gaming. The minimum age value for that jurisdiction may then be compared with the age value for that user, to determine if real-money gaming is authorized (in addition to the comparison made regarding the skill-level value for the requested videogame). For instance, in a given jurisdiction, the minimum age of a user to engage in real-money gaming may be 21 years old. If the age value for the user is “18”, where “18” is inferior to the minimum age value of “21” for that given jurisdiction, a Boolean value of “false” could be generated following the comparison”, even if the videogame has a skill-level value that equals to or exceeds that of the threshold skill level value for the given jurisdiction.

Other characteristics of the user, equally associated with and sharable from the profile, such as marital status, may also be verified.

### Exemplary Method of Calculating a Skill-Level Value for an Exemplary Videogame:

Reference is now made to FIG. 4, illustrating an exemplary method 400 of calculating a skill-level value for an exemplary videogame. For illustrative purposes, reference will be made to system 100 and to software architecture 200. However, it will be understood that other systems and/or software architectures may be used in accordance with the present teachings.

Data for a new videogame including a real-money gaming setting, to be added to an exemplary videogame platform, is received at step 410.

The reception of the new videogame data results in the processor 171 initiating a trial session for the corresponding videogame (e.g. by executing the program code of trial session submodule 211), accessible by users through a graphical user interface for the videogame platform appearing on a display of the computing devices 150, where the videogame is set in or limited to a virtual-currency mode, at step 420. During this trial session, the videogame is made available on the platform to users in the virtual-currency mode. Users may engage in player-versus-player games (where the games may, e.g., be one-versus-one, or includes teams-vs-teams, or a battle royale setting where a plurality of players face off each other, etc.).

Optionally, each of the users that participates in the trial session may be assigned with a raw Elo rating at step 430, based on the gaming history for that user (e.g. the wins and losses of the players, and based on their expected results with regard to the other users engaged in the virtual session). For instance, the Elo ratings of the players may be attributed following the Glicko methodology (e.g. the Elo ratings may include an initial rating of 1500 and a rating deviation of 350).

The users then complete a plurality of trial matches of the videogame in real-currency mode. The win-loss outcomes for each of the matches, along with the user identifier for each of these matches, is received at the server 150 as win-loss data and stored in memory 172 as a dataset by the processor 171 executing the program code, e.g., of trial session submodule 211.

After that a number of games is completed during the trial session and the win-loss dataset is sufficiently large and/or detailed (e.g. determined based on conditions verified by the processor 171 executing the program code of trail session submodule 211), adjusted Elo ratings are calculated for each of the players by the processor 171 executing program code, e.g., of skill-level value submodule 212, at step 440. The processor 171 executes a grid-search algorithm stored in memory by inputting the win-loss data for the users engaged in the trial session, the win-loss data including values for wins and values for losses that are associated with the users (e.g. user identifiers) and their adversaries during the matches, to calculate a k value. The k value indicates by how much Elo ratings are adjusted after observing a deviation of the actual score from the expected score in each match.

The processor, executing program code stored in memory, retrieves and uses the calculated k value, minimizing overall loss, to calculate the adjusted Elo ratings, indicative of the odds of a user winning against another user, then adjusted if a predicted weak user defeats a predicted stronger player, where possible user-permutations are analyzed.

For instance, the grid-search algorithm may start with an initial list of values for k. For each of these k values, the overall loss may be computed on the dataset. The k value minimizing this loss may be selected, and a new array of k values centered around this k value with minimal loss may be generated, having a smaller step between the values. The process including the grid-search algorithm may be repeated until a desired minimal overall loss is obtained (e.g. under 10⁻⁶) or until a number of iterations of the process is performed (e.g. a maximum of 50 iterations).

A confidence interval for the adjusted Elo rating dataset for the sample users is measured by the processor 171 (e.g. executing program code of skill-level value submodule 212) at step 450. The confidence interval is measured by adjusting the win-loss dataset for the sample users, and then by measuring a change in the standard deviation previously determined for the videogame. The following are exemplary actions for varying the win-loss dataset for the sample users: for instance, data for a number of additional matches between users may be added, data for a number of matches currently used in the calculation of the adjusted Elo rating dataset may be removed, certain users of the users for the trial session may be removed, or additional users for the trial session may be added and their adjusted Elo ratings may be calculated, and the difference in the standard deviation of the adjusted Elo rating dataset may then be calculated. As the standard deviation follows a normal distribution, the confidence intervals resulting from the number of samples in the dataset may be calculated. A large confidence interval means that it is preferable to gather more samples in order to get a more accurate result.

The standard deviation of the Elo ratings (that have been calculated with the optimal k value) can then be used to determine a level of skill involved for the videogame. The greater the standard deviation, the more skill the game involves. The lesser the standard deviation, the less skill the videogame involves.

The change in the standard deviation of the Elo rating dataset (from before and after the change in the win-loss dataset) is then measured at step 460 (e.g. processor executing the program code of skill-level value submodule 212) to verify if the change falls within a confidence interval or meets a set confidence interval. For instance, the tolerance level may be set to a value of 1%, etc. If the changes in the standard deviation do not fall within the acceptable tolerance level, then additional data is collected by running additional games between users during a trial session in virtual currency mode at step 420. During these additional games, new users may be allowed to play, more games are run between the current users already participating in the trial session, etc. The additional data collected from the additional games is added to the original data collected from the first set of games during the trial session, and steps 430 to 460 are repeated. At steps 450 and 460, the standard deviation is again tested to measure its confidence interval, and compared to the set tolerance level, to determine if steps 430 to 460 are to be further repeated if it is determined that the change is not in the acceptable confidence interval.

On the other hand, if the change in the standard deviation is measured as being within the acceptable confidence interval, then a skill-level value for the given videogame is calculated from the standard deviation for the videogame at step 470 by processor, executing the program code of, e.g., skill-level value submodule 212. The greater the standard deviation, the greater the skill level of the videogame. The lesser the standard deviation, the lesser the skill level of the videogame. The skill-level value is a number (e.g. a relative number) attributed by the system correlated to the level of skill required by players to perform in the videogame. As the skill-level value is a relative number, the value attributed to a videogame depends upon the scale used by the system to measure skill-levels for the videogames hosted on its platform. For instance, for certain systems, a larger number may be attributable to a greater skill level. However, a skilled person would readily understand that for other systems, based on a different scale, a smaller number for that system may instead be assigned when a greater skill-level is determined.

For instance, exemplary skill-level values may be calculated from standard deviations of Elo ratings generated from synthetic data. The level of chance in these synthetic examples may be controlled, where these synthetic examples are used to calculate the potential skill-level values (e.g. from 0% skill to 100% skill). The computed standard deviation for a specific videogame is then compared to the skill-level values generated from the synthetic examples, and a skill-level value corresponding to that of the synthetic example with the closest standard deviation is then assigned to the target videogame.

The skill-level value for the videogame is stored in memory with a label for the videogame (e.g. by processor executing the program code of, e.g., skill-level value submodule 212), the label acting as an identifier for the videogame that can be retrieved and parsed by the processor 171 whenever a request is received to play the videogame in real-currency mode, as explained with respect to FIG. 5.

It will be understood that in some embodiments, a chance-level value may be calculated for the videogame instead of a skill-level value. The chance-level value increases as the standard deviation decreases, and the chance-level decreases as the standard deviation increases. A skilled person would understand that the magnitude of a chance-level value is opposite to the magnitude of a skill-level value for a given game. For purposes of the present disclosure, when reference is made to “skill-level value”, the expression may refer to a value corresponding to a skill required to play a game, or the chance involved in playing a game, as both of these elements are related (i.e. reliance on more skill entails less reliance on chance, and vice-versa).

In some examples, data for a videogame received by the videogame platform may include multiple sub-games or modes, where every sub-game or mode may require a different amount of skill to play. In these examples, method 400 may be performed for each of these sub-games or modes. For instance, a videogame may include two modes, where in the first mode, a player is required to shoot another player and gains points every time the player manages to secure a hit. In the second mode, both of players may instead target moving objects or hostile units, where every time a player hits a target, that player acquires points. These two modes, as they involve different game mechanics, may not each entail the same amount of skill by the players to perform in the game, and as such, would result in two separate skill-level values, one for each mode of the videogame.

### Updates Performed on Videogames Hosted on the Videogame Platform:

In some examples, a videogame hosted on the videogame platform may receive updates from, e.g., the game developer. In these examples, the update to the videogame may affect the skill-chance balance for the videogame. For instance, an update to a videogame for a player-versus-player combat game between players may introduce, by way of the update, random weapon generation during the battle that could increase or decrease the strength of a given player. Such an update may provide a less-skilled player with a combat advantage over a more-skilled player if the less-skilled player receives a more powerful weapon resulting from the random weapon generation. Another example would be in the case of a virtual trading card game, such as MTG Arena™ from Wizards of the Coast™, where an update could introduce new cards with a mechanic that produces random card effects every time the card is activated, the card effects ranging in strength. This new mechanic would increase the chance during a match that the random effect would provide a less-skilled player with an advantage over the more-skilled player, if the activation of the mechanic provides the less-skilled player with an effect that would advantage its position at that stage of the game.

As such, the system 100 and method 400 may also be performed when a videogame currently hosted on the videogame platform, which already has a skill-chance level value stored in memory on server 120, receives a videogame update. The updated videogame undergoes a trial session in virtual-currency mode, and steps 420-460 are performed. The newly calculated skill-chance level is stored in memory, and can replace the previously-calculated skill-chance level value for that videogame, associated with the identifier for that videogame. In other embodiments (e.g. where users may initiate different versions of a same videogame), the calculated skill-chance level value for the given videogame may instead be stored with a new identifier, e.g., “GAMEXXXX1.2” (e.g. with a number indicative of the version of the videogame corresponding to the videogame). As such, when a request is received from a user to play a videogame in virtual currency mode, the request may include the identifier for the videogame and its version that can then be used in the query for retrieving from memory the skill-chance level value for that videogame (as explained with respect to FIG. 4), therefore resulting in the retrieval of the skill-chance level value of the appropriate version of the videogame.

### Determining the Threshold Skill-Level Value for a Given Jurisdiction:

The skill-level threshold value for a given jurisdiction may be obtained from a fixed value provided in the laws for that jurisdiction, calculated from or based on an example of a threshold game provided in the legislation or case law for that jurisdiction indicative of a minimum amount of skill required to allow real-money gaming (e.g. the laws may provide poker as an example of a game with a minimum level of skill involved for allowing real-money gaming), from case law (decisions) generated by the relevant courts deciding if certain games are eligible or ineligible for real-money gaming, etc.

For instance, in embodiments where a jurisdiction provides an example of a game that has a minimum level of skill required for permitting real-money gaming, or an example of a game lacking the minimum level of skill required for permitting real-money gaming (or when either of these exemplary games are provided in case law for that jurisdiction):
research can be conducted in literature to determine if a standard deviation of adjusted Elo ratings (such as explained in FIG. 5) has already been calculated for that game, and that standard deviation can be used to calculate the skill-level rating stored and used by the exemplary system 100 for that jurisdiction; or
a method similar to method 500 can be performed for that given game, and data can therefore be generated and analyzed to calculate a skill-level rating for that game, as explained with regard to FIG. 5. In the scenario where the threshold game is considered by that jurisdiction to have a sufficient level of skill to permit real-money gaming, when data is collected by performing the steps of method 500, the game can instead be run in real-money mode instead of virtual currency mode for users located in that jurisdiction as that jurisdiction has already declared that the threshold game is eligible for real-money gaming.

In some examples where real-money gaming is forbidden for a given jurisdiction, a value may be stored in memory 172, associated with an identifier for that jurisdiction, indicative that no real-money gaming is permitted for that jurisdiction.

### Example of Interaction Between a Content Management System and Information Stored in a Database:

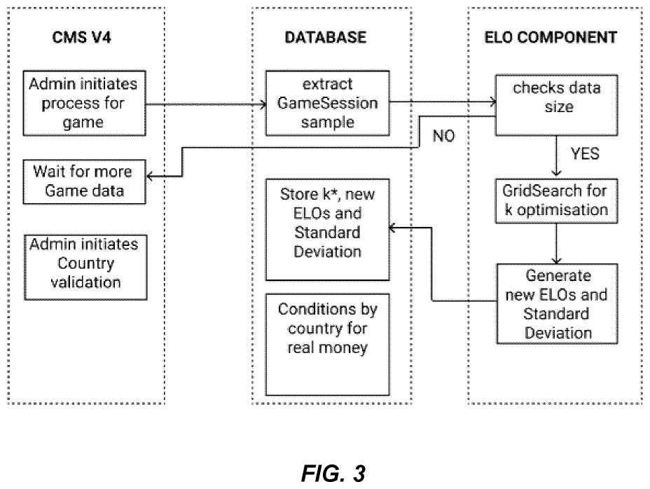

The system 100 may include a content management system (CMS) which may run, e.g., at the server 120. The content management system may manage the win-loss data for generating skill-level values for videogames hosted on the videogame platform, as shown in FIG. 3.

An administrator may initiate a process for a videogame hosted on the videogame platform to calculate the skill-level value for a videogame (e.g. that has been newly added to the videogame platform; that has received an update). In other embodiments, the calculation of the skill-level value for the videogame may be initiated automatically upon addition of the videogame, or upon receipt of the update to the videogame.

The win-loss data for the videogame is extracted from a database or memory 172. A verification can be performed upon extraction of the win-loss data to verify if the win-loss data is sufficiently large and/or varied (e.g. enough matches from a large enough variety of players), by comparing the win-loss data to a threshold value. If the win-loss data does not meet the condition(s) for size, then the content management system waits a period of time for more win-loss data to be generated for the given videogame.

However, if the win-loss data does meet the condition(s) for size, the processor 171 executes the grid-search algorithm on the win-loss data to generate the k factor and the Elo ratings, and calculates the standard deviation from the generated Elo ratings.

The skill-level value for the videogame may be calculated from the standard deviation.

One or more of the k* factor, the Elo ratings and the standard deviation, the skill-level value, etc., may be stored in memory 172 or in an external database.

The external database may also include the conditions or standards for each jurisdiction for permitting real-money gaming.

Therefore, an administrator may also initiate from the content management system a validation that a particular videogame meets the conditions for a given jurisdiction to allow real-money gaming.

The content management system may also initiate the validation that a particular videogame meets the conditions for a given jurisdiction to allow real-money gaming upon receiving a request from a user to play the videogame in real-money gaming mode, for instance as explained with regard to FIG. 5.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

What is claimed is:

1. A method of authorizing real-money gaming for a videogame selected by a user, through a computing device of the user, amongst a plurality of videogames hosted on a videogame platform, comprising:
receiving a request from a user to play a target videogame, from the plurality of videogames, in a real-money gaming mode;
receiving location information of the computing device of the user;
analyzing the location information to determine a jurisdiction in which the computing device is located;
retrieving a skill level value for the target videogame, wherein the skill level value is determined from a standard deviation of Elo ratings calculated for a plurality of sample users for the target videogame;
retrieving a skill level threshold value for the jurisdiction; and
determining if the skill level value of the videogame meets the skill level threshold value for the jurisdiction, wherein real-money gaming is authorized for the target videogame if the skill level value of the videogame meets the skill level threshold value for the jurisdiction.

2. The method as defined in claim 1, wherein the skill level value is further determined by:
running a trial session for the target videogame in a virtual currency mode including a plurality of matches between the sample users to generate win-loss data;
calculating the Elo rating values for each of the sample users based on an analysis of the win-loss data including the wins and losses between the plurality of sample users during the matches;
calculating the standard deviation from the calculated Elo rating values; and
computing the skill level value for the selected video from the standard deviation.

3. The method as defined in claim 2, further comprising, prior to the computing of the skill level value, determining a confidence interval for the standard deviation by modifying some of the data of the win-loss data.

4. The method as defined in claim 3, wherein the modifying of some of the data of the win-loss data includes removing some of the data associated with one or more of the matches.

5. The method as defined in claim 3, wherein the modifying of some of the data of the win-loss data includes adding additional data to the win-loss data by including further matches between the sample users.

6. The method as defined in any one of claims 2 to 5, wherein the calculating of the Elo rating values is performed using a grid-search algorithm.

7. The method as defined in claim 6, wherein the grid-search algorithm is adjusted to minimize a sum of total losses across an entire dataset of the calculated Elo ratings.

8. The method as defined in any one of claims 1 to 5, wherein the request received from the user includes information on a version of the videogame to be played, and wherein the retrieving the skill level value for the videogame is performed using a query including information on the version of the videogame such that the retrieved skill level value for the videogame is specific to the version of the videogame.

9. The method as defined in any one of claims 1 to 8, further comprising:
receiving age information for the user including an age value for the user;
receiving a value for a minimum authorized age for the jurisdiction for permitting real-money gaming; and
comparing the age value for the user to the value for the minimum authorized age, wherein real-money gaming is authorized for the target videogame if the skill level value of the videogame meets the skill level threshold value for the jurisdiction and if the age value for the user meets the value of the minimum authorized age.

10. The method as defined in claim 9, wherein the age information is received with the request.

11. The method as defined in claim 10, wherein the age information is received following a generating of a query based on user information of the user provided in the request, wherein the query is for retrieval of the age information associated with the user information.

12. A method of calculating a skill level value for a target videogame, wherein the target videogame includes a real-money gaming mode, and wherein the skill level value provides an indicator of a level of skill required to play the videogame and is usable to determine if real-money gaming is permitted for the videogame when played by a user located in a given jurisdiction, comprising:
running a trial session for the target videogame in a virtual currency mode including a plurality of matches between sample users to generate win-loss data;
calculating the Elo rating values for each of the sample users based on an analysis of the win-loss data including the wins and losses between the plurality of sample users during the matches;
calculating a standard deviation from the calculated Elo rating values; and
computing the skill level value for the selected video from the standard deviation.

13. The method as defined in claim 12, further comprising, prior to the computing of the skill level value, determining a confidence interval for the standard deviation by modifying some of the data of the win-loss data.

14. The method as defined in claim 13, wherein the modifying of some of the data of the win-loss data includes removing some of the data associated with one or more of the matches.

15. The method as defined in claim 13, wherein the modifying of some of the data of the win-loss data includes adding additional data to the win-loss data by including further matches between the sample users.

16. The method as defined in any one of claims 13 to 15, wherein, if the confidence interval does not meet a minimal confidence value, the running is repeated to generate additional win-loss data, the calculating the Elo rating values is repeated by being further based on the additional win-loss data to yield new Elo rating values, and a new standard deviation is calculated from the new Elo rating values.

17. The method as defined in any one of claims 12 to 16, wherein the calculating of the Elo rating values is performed using a grid-search algorithm.

18. The method as defined in claim 17, wherein the grid-search algorithm is adjusted to minimize a sum of total losses across an entire dataset of the calculated Elo ratings.

19. The method as defined in any one of claims 12 to 18, wherein the running, the calculating the Elo rating values, the calculating the standard deviation, and the computing the skill level value are repeated when the target videogame receives an update.

20. A computing device configured to authorize real-money gaming for a videogame selected by a user, through a computing device of the user, amongst a plurality of videogames hosted on a videogame platform, comprising:
a processor; and
memory storing program code that, when executed by the processor, causes the processor to:
receive a request from a user to play a target videogame from the plurality of videogames in a real-money gaming mode;
receive location information of the computing device of the user;
analyze the location information to determine a jurisdiction in which the computing device is located;
retrieve a skill level value for the target videogame, wherein the skill level value is determined from a standard deviation of Elo ratings calculated for a plurality of sample users for the target videogame;
retrieve a skill level threshold value for the jurisdiction; and
determine if the skill level value of the videogame meets the skill level threshold value for the jurisdiction, wherein real-money gaming is authorized for the target videogame if the skill level value of the videogame meets the skill level threshold value for the jurisdiction.
